(19) United States
(12) Patent Application Publication
(10) Pub. No.: US 2018/0075114 A1
(43) Pub. Date: Mar. 15, 2018

(54) Petrochemical Equipment Corrosion Treatment Method, Apparatus and System

(71) Applicant: Sinopec Engineering (Group) Co., Ltd., Beijing (CN)

(72) Inventors: Fengchang YU, Luoyang (CN); Chonggang CHEN, Luoyang (CN); Yongfeng DUAN, Luoyang (CN); Guoxin ZHANG, Luoyang (CN); Xin'an CUI, Luoyang (CN); Xiaoyan ZHAO, Luoyang (CN); Jing XU, Luoyang (CN)

(73) Assignee: Sinopec Engineering (Group) Co., Ltd., Beijing (CN)

(21) Appl. No.: 15/552,233

(22) PCT Filed: Jul. 27, 2016
(86) PCT No.: PCT/CN2016/091961

§ 371 Date: Aug. 18, 2017

(30) Foreign Application Priority Data
Jul. 28, 2015 (CN) 201510452238.2

(51) Int. Cl. G06F 17/30

(52) U.S. Cl. CPC G06F 17/30542; G06F 17/30864; G06F 17/30598

(57) ABSTRACT

The present invention relates to the field of petrochemical information processing. Provided are a petrochemical equipment corrosion treatment method, apparatus, and system. The petrochemical equipment corrosion treatment method comprises: adopting a corrosion environment parameter analysis method, first acquiring a query request, and determining a corrosion type of petrochemical equipment according to a corrosion environment parameter of the petrochemical equipment in the query request (S101); further retrieving a corrosion record corresponding to the corrosion type (S102); and sending the corrosion record to a specified terminal (S103). Thus, related personnel can receive and read a corrosion record by means of a specified terminal, such that the related personnel can obtain corresponding references during corrosion treatment on petrochemical equipment. Even a novice without much working experience can perform corresponding treatment according to content in a corrosion record, thereby improving the success rate and accuracy of corrosion treatment on petrochemical equipment.

### TECHNICAL FIELD

The present invention relates to the field of petrochemical information processing, and specifically to a method, an apparatus and a system for treatment of corrosion of petrochemical equipment.

### BACKGROUND ART

With the progress of science and technology, people's living standards are progressively improved year by year. One primary indicator for evaluating living standards is the degree of automation and the degree of life convenience. For example, works traditionally done by manpower are now completed by mechanical equipment, which is a main manifestation of the improvement of the degree of automation and the improvement of the degree of life convenience.

The improvement of the degree of automation relies on the use of energy, and common kinds of energy are electric energy, fossil energy and the like. In order to further improve the degree of automation, it becomes increasingly important to know how to highly-efficiently and safely produce energy and it also gets more and more attention.

Petroleum is an important constituent part of fossil energy, and accordingly, the safety problem of production of petroleum has also drawn extensive attention. With the rapid economic growth of China, the quantity demand for petroleum made by the consumer market gets greater and greater, and China has become the second largest petroleum consuming country of the world. The refining and chemical enterprises in China usually adopt a method of processing inferior crude oil of high sulfur content and high acid content, so as to reduce the cost of oil refining and thereby increase economic benefits. During the processing of inferior crude oil of high sulfur content and high acid content, the corrosion problem of petrochemical equipment has always been a key problem troubling the safety production and long-period running of oil refining apparatuses. In recent years, accidents caused by corrosion failure of material of petrochemical equipment occur frequently, and equipment engineers and corrosion engineers of refining and chemical enterprises usually need technical analysis of the corrosion accidents to find out the essential reason for the occurrence of various corrosion accidents, so as to provide data basis for corrosion prediction and prevention, and for performance of targeted anti-corrosion measurements.

Corrosion failure of the material of petrochemical equipment is a complex procedure, which not only relates to technological conditions, but also relates to aspects such as trace substances in a process medium and the kinds of a material used, and to a heat treatment condition of the material. Thus, the corrosion failure of petrochemical equipment is a complex procedure influenced by multiple factors, which is difficult to be evaluated using a quantitative standard. Thus, in the aspects of performing corrosion failure determination of petrochemical equipment and equipment maintenance, it relies to a greater extent on the knowledge and experience accumulation of the corrosion failure analysts (it mainly lies in that the corrosion failure analysts have experienced a large amount of practical cases, making them understand which treatment should to be performed in a certain circumstance). Accordingly, it results in that it is difficult for young corrosion failure analysts to make an accurate determination due to little processing experience of practical cases, and due to a smaller amount of elder corrosion failure analysts, it is difficult to deal with a large amount of corrosion failure cases in time.

### DISCLOSURE OF THE INVENTION

In view of this, an object of the present invention is to provide a method, an apparatus and a system for treatment of corrosion of petrochemical equipment, so as to improve accuracy when a relevant person is dealing with a corrosion failure case.

In a first aspect, the present invention provides a method for treatment of corrosion of petrochemical equipment, including the steps of:

acquiring a query request, the query request carrying a corrosion environment parameter of the petrochemical equipment, wherein the corrosion environment parameter includes one or more of corrosive medium, temperature, flow rate and material;

acquiring a corrosion record according to the corrosion environment parameter, wherein the corrosion record includes one or more of: basic characteristics of corrosion, corrosion mechanisms, corrosion morphologies, sensitive materials, influencing factors, corrosion-prone apparatuses and equipment, monitoring and detecting modes, protective measures and failure cases; and sending the corrosion record to a preset (specified) network terminal.

In combination with the first aspect, the present invention provides a first possible embodiment of the first aspect, wherein the step of acquiring a corrosion record according to the corrosion environment parameter includes the steps of:

determining a corrosion category of the petrochemical equipment according to the corrosion environment parameter, the corrosion category including corrosion thinning, stress corrosion cracking, mechanical fatigue and metallurgy failure;

determining, according to the corrosion environment parameter, a corrosion type of the petrochemical equipment by using a corrosion determining algorithm corresponding to the corrosion category; and

querying a corrosion record corresponding to the corrosion type.

In combination with the first aspect, the present invention provides a second possible embodiment of the first aspect, wherein the step of acquiring a corrosion record according to the corrosion environment parameter includes the steps of:

calculating a corrosion rate of the petrochemical equipment according to the corrosion environment parameter; and

querying a historic record corresponding to the corrosion rate, with the historic record as a corrosion record.

In combination with the first aspect, the present invention provides a third possible embodiment of the first aspect, wherein the step of querying a corrosion record corresponding to the corrosion type includes the steps of:

querying, from a corrosion case database, a historic case corresponding to the corrosion type, with the historic case as the corrosion record;

wherein the historic case includes one or more of conduit data, container data, tower data, reactor data, heat exchanger data, air cooler data and heating furnace data.

In combination with the first aspect, the present invention provides a fourth possible embodiment of the first aspect, wherein the step of querying from a corrosion case database a historic case corresponding to the corrosion type with the historic case as the corrosion record includes the steps of:

acquiring a query type of the historic case from the query request; and

querying the historic case in a database corresponding to the query type of the historic case, wherein the query type includes one or more of apparatus type, equipment type, equipment name, corrosion location and medium type.

In combination with the first aspect, the present invention provides a fifth possible embodiment of the first aspect, wherein the step of querying from a corrosion case database a historic case corresponding to the corrosion type with the historic case as the corrosion record includes the steps of:

acquiring a query type of the historic case from the query request; and

querying the historic case in a database corresponding to the query type of the historic case, wherein the query type includes one or more of apparatus type, equipment type, equipment name, corrosion location and medium type.

In combination with the first aspect, the present invention provides a sixth possible embodiment of the first aspect, wherein the step of querying from a corrosion case database a historic case corresponding to the corrosion type with the historic case as the corrosion record includes the steps of:

querying a name of the historic case corresponding to the corrosion type from a name list of the corrosion case database; and

querying, from a data storage of the corrosion case database, a case corresponding to the name of the historic case, with the queried case as the corrosion record.

In a second aspect, the present invention further provides an apparatus for treatment of corrosion of petrochemical equipment, including:

acquiring a query type of a historic case from the query request; and

querying the historic case in a database corresponding to the query type of the historic case, wherein the query type includes one or more of apparatus type, equipment type, equipment name, corrosion location and medium type.

In combination with the second aspect, the present invention provides a first possible embodiment of the second aspect, wherein the acquisition module includes:

a first determining unit configured for determining a corrosion category of the petrochemical equipment according to the corrosion environment parameter, the corrosion category including corrosion thinning, stress corrosion cracking, mechanical fatigue and metallurgy failure;

a second determining unit configured for determining, according to the corrosion environment parameter, a corrosion type of the petrochemical equipment by using a corrosion determining algorithm corresponding to the corrosion category; and

a query unit configured for querying a corrosion record corresponding to the corrosion type.

In a third aspect, the present invention provides a system for treatment of corrosion of petrochemical equipment, including: a client and a server,

wherein the client is used for acquiring a corrosion environment parameter of the petrochemical equipment and sending the corrosion environment parameter of the petrochemical equipment to the server via an Internet; and

the server includes the apparatus for treatment of corrosion of petrochemical equipment provided by any one of the preceding second aspect.

The method for treatment of corrosion of petrochemical equipment provided in the present invention adopts an analysis method of corrosion environment parameter. Comparing with the prior art, in which when encountering corrosion problem of petrochemical equipment, a coping strategy is given based on analysis and determination that are performed ambiguously regarding the currently encountered corrosion problem only via the personal experience of an analyst, the method acquires a query request firstly, and determines a corrosion type of the petrochemical equipment according to a corrosion environment parameter of the petrochemical equipment in the query request, and then retrieve a corrosion record corresponding to this corrosion type, and sends it to a preset terminal, such that relevant person can receive and read the corrosion record via the preset terminal, which enables the relevant person to obtain corresponding reference and guide when performing the treatment on corrosion of the petrochemical equipment. Even a green hand having not much professional experience can also perform corresponding treatment according to the content in the corrosion record, improving the success rate and the accuracy of the treatment performed on the corrosion of the petrochemical equipment.

In order to make the objects, features and advantages of the present invention mentioned above clearer and easier to understand, preferable examples will be particularly enumerated in the following, and detail description with reference to the attached drawings is made as follows.

### BRIEF DESCRIPTION OF THE DRAWINGS

In order to more clearly illustrate the technical solutions of the examples of the present invention, the drawings to be used in the examples will be simply presented below; and it shall be understood that the following drawings only show certain examples of the present invention, and thus shall not be deemed as limiting to the scope thereof, and for a person skilled in the art, further relevant drawings could be obtained according to these drawings without using inventive efforts.

FIG. 1 shows a basic flow chart of a method for treatment of corrosion of petrochemical equipment provided in an example of the present invention;

FIG. 2 shows an optimized flow chart of the method for treatment of corrosion of petrochemical equipment provided in an example of the present invention;

FIG. 3 shows a systematic structure schematic view of the method for treatment of corrosion of petrochemical equipment provided in an example of the present invention; and

FIG. 4 shows a basic structure schematic view of an apparatus for treatment of corrosion of petrochemical equipment provided in an example of the present invention.

### DETAILED DESCRIPTION OF THE EMBODIMENTS

In the following contents, clear and complete description regarding the technical solutions of the examples of the present invention will be made with reference to the drawings in Examples of the present invention, and obviously, the described examples are merely some but not all examples of the present invention. Generally, the components of the examples of the present invention described and shown in the drawings here can be arranged and designed in various different configurations. Thus, the following detailed description of the examples of the present invention provided in the drawings merely illustrates selected examples of the present invention, rather than limiting the scope of the present invention for which protection is sought. Based on the examples of the present invention, all further examples that could be obtained by a person skilled in the art without using inventive efforts fall in the scope of protection of the present invention.

With the development and utilization of the petroleum energy, equipment for producing petroleum become increasingly advanced, however, no matter how advanced the petrochemical equipment is, it still will be faced with the problem of corrosion, which will also cause it difficult to realize normal work and running of the petrochemical equipment, and even cause other related production problems.

In related technology, people will perform maintenance and overhaul on petrochemical equipment according to their own practical experiences. It also results in that it is difficult for young analysts to make an accurate determination, and although an elder person can make accurate determination, however, due to a small number of the elder persons, it is a drop in the bucket when facing with a great number of petrochemical equipment. Moreover, corrosion failure of petrochemical equipment is a complex problem, and specifically, there are many factors that influence the corrosion failure of petrochemical equipment, such as trace substances in a process medium, the kind of a material used, and a heat treatment condition, etc., and these factors would result in influences on the corrosion failure of the petrochemical equipment to a certain degree. Thus, it is difficult to precisely enumerate a function relational expression regarding the corrosion failure of petrochemical equipment by means of mathematical or physical relational expression. Because of knowing corrosion failure cases in many different circumstances, an experienced analyst can directly make a corresponding determination by means of “ambiguous control”, even though it is also difficult for this analyst to indicate the theoretical reason for making this determination.

In practical operations, partial analysts can make a corresponding determination and put forward a proposal of overhaul and diagnosis according to the currently confronted situation; however, there are still certain problems. Analysts might subjectively value some factors, or neglect and forget some factors, which would result in that the determination made by the analysts is not accurate enough. Moreover, for another part of analysts who are less experienced, even though they have fully understood various factors, it is still difficult for them to make a correct determination, due to lack of experiences.

In view of this, an example of the present application provides a method for treatment of corrosion of petrochemical equipment, which, as shown in FIG. 1, includes the steps of:

S101, acquiring a query request, the query request carrying a corrosion environment parameter of the petrochemical equipment, wherein the corrosion environment parameter includes one or more of corrosive medium, temperature, flow rate and material;

S102, acquiring a corrosion record according to the corrosion environment parameter, wherein the corrosion record includes one or more of: basic characteristics of corrosion, corrosion mechanisms, corrosion morphologies, sensitive materials, influencing factors, corrosion-prone apparatuses and equipment, monitoring and detecting modes, protective measures and failure cases; and

S104, sending the corrosion record to a preset network terminal.

It should be noted that it is a terminal/server with a database, which carries out the method for treatment of corrosion of petrochemical equipment provided in the present application. In Step S101, the acquired query request may be sent by a remote client. In addition to the corrosion environment parameter of the petrochemical equipment, the query request may also carry product information about this petrochemical equipment, such as product number, manufacture factory and the like, for facilitating statistics. The remote client may be in communication with a local terminal/server in the form of Internet or a local area network.

Specifically, in order to assure the safety of the query request, an encryption processing can be performed on the whole query request or on partial data in this query request before the client sends this query request out, for example, processing may be performed on the corrosion environment parameter.

In Step S102, the server needs to determine a corresponding corrosion type of the petrochemical equipment according to the received corrosion environment parameter, wherein the corrosion environment parameter may include corrosive medium, temperature, flow rate, material and the like. Of course, the more comprehensive the kinds of the corrosion environment parameter are, the more specific and precise the parameter is, and the more accurate the determination made about the corrosion type is.

After the determination of the corrosion type, the system can retrieve data, i.e. corrosion record, corresponding to this corrosion type. It should be noted that the contents of the corrosion record are stored in advance in the server, and during the storage, various different corrosion records are stored in a classified manner. For example, the corrosion record includes: basic characteristics of corrosion, corrosion mechanisms, corrosion morphologies, sensitive materials, influencing factors, corrosion-prone apparatuses and equipment, monitoring and detecting modes, protective measures and failure cases. In the course of storage, these eight parts may be stored separately, and different retrieval conditions may be set, such that specified data contents can be accurately and rapidly searched during the search.

Finally, in Step S103, the server sends the queried corrosion record to a preset network terminal. The preset network terminal here may be a client sending a query request, or other network terminal, that is to say, the client sending a query request is only a terminal providing in-site data of the petrochemical equipment, while in the final step S104, the network terminal to which the corrosion record is sent may be a terminal responsible for data statistics.

The acquiring step carried out in Step S102 requires the preparation of corresponding reference standards and case contents in advance.

For example, in Step S102, before performing the determination of the corrosion type, a computing system of the server firstly needs to know parameter ranges corresponding to different corrosion types, wherein once the corrosion environment parameter falls within a preset parameter range, the corrosion type corresponding to this corrosion environment parameter can be determined, and accordingly, the corrosion type of the petrochemical equipment can be known.

A corresponding corrosion record is searched according to the corrosion type. The corrosion record can be divided into two kinds: one being guiding suggestions and general data, e.g. basic characteristics of corrosion, corrosion mechanisms, corrosion morphologies, sensitive materials, influencing factors, corrosion-prone apparatuses and equipment, monitoring and detecting modes and protective measures; and the other being historic cases (failure cases). In these two kinds of corrosion records, the update frequency for the guiding suggestions and general data is relatively low, as this kind of contents is usually obtained by summarizing a great amount of cases, and since reference has already been made to a great amount of data when making summarization, generally no change will be made because of temporarily added individual cases; whereas real-time update is necessary for historic cases, and compared with the guiding suggestions and general data, the historic cases have higher reference value, when a user performs analysis and maintenance according to the corrosion record, just occurred cases usually have a very high reference value, thus, whether the historic cases are updated in time also determines the reference value of the corrosion record to a certain degree. Therefore, the method for treatment of corrosion of petrochemical equipment provided in the present application further includes the step of updating the failure cases at a predetermined time interval.

It should be noted that the guiding suggestions and general data in the corrosion record include: 65 types of corrosion damage, mainly including: hydrochloric acid corrosion, naphthenic acid corrosion, high-temperature sulfur corrosion, carbon dioxide corrosion, oxidation corrosion, microbiological corrosion, flue gas dew point corrosion, soot corrosion, ammonium chloride corrosion, sulfuric acid corrosion, phosphoric acid corrosion, hydrofluoric acid corrosion, high-temperature hydrogen corrosion, high-temperature hydrogen/sulfureted hydrogen corrosion, acidic water corrosion, wet sulfureted hydrogen corrosion, electrochemical corrosion, amine corrosion, caustic alkali corrosion, washout, cavitation, soil corrosion, atmospheric corrosion, cooling water corrosion, boiler water corrosion, phenol corrosion, corrosion under insulation, chloride SCC, nitrate SCC, caustic alkali SCC, carbonate SCC, amine SCC, polythionic acid SCC, wet sulfureted hydrogen damage, ammonia stress corrosion cracking, hydrofluoric acid SCC, hydrogen embrittlement, metal pulverization, demetalization, graphitization, carburization, decarburization, nitridation, metal pulverization, temper embrittlement, embrittlement at 475° C., hydrogen embrittlement, reheating cracking, mechanical fatigue, stress aging, liquid metal embrittlement, thermal shock, brittle fracture and so on. Before the search is performed, the following table can be firstly established:

TABLE 1

| | | | | | | | Corrosion-prone |
|---|---|---|---|---|---|---|---|
| | Type of corrosion | Basic | Corrosion | Corrosion | Sensitive | Influencing | apparatuses and |
| No. | damage | characteristic | mechanism | morphology | material | factor | equipment |
| 1 | Hydrochloric acid | A1 | B1 | C1 | D1 | E1 | F1 |
| | corrosion | | | | | | |
| 2 | Naphthenic acid | A2 | B2 | C2 | D2 | E2 | F2 |
| | corrosion | | | | | | |
| 3 | High-temperature | A3 | B3 | C3 | D3 | E3 | F3 |
| | sulfur corrosion | | | | | | |
| 4 | Carbon dioxide | A4 | B4 | C4 | D4 | E4 | F4 |
| | corrosion | | | | | | |
| 5 | Oxidation | A5 | B5 | C5 | D5 | E5 | F5 |
| | corrosion | | | | | | |
| 6 | Microbiological | A6 | B6 | C6 | D6 | E6 | F6 |
| | corrosion | | | | | | |
| . . . | . . . | . . . | . . . | . . . | . . . | . . . | . . . |

In Table 1, different factors corresponding to different types of corrosion damage are listed according to different numbers, and during search, the system may perform corresponding retrieval according to a received retrieval condition or a retrieval condition obtained via search. Here, in order to improve the retrieval speed, the established table may exist in the form of a hash table, specifically, that is, the types of corrosion damage are converted into the form of hash values, and then the retrieval may be performed in the hash retrieval mode, so as to accelerate the retrieval speed.

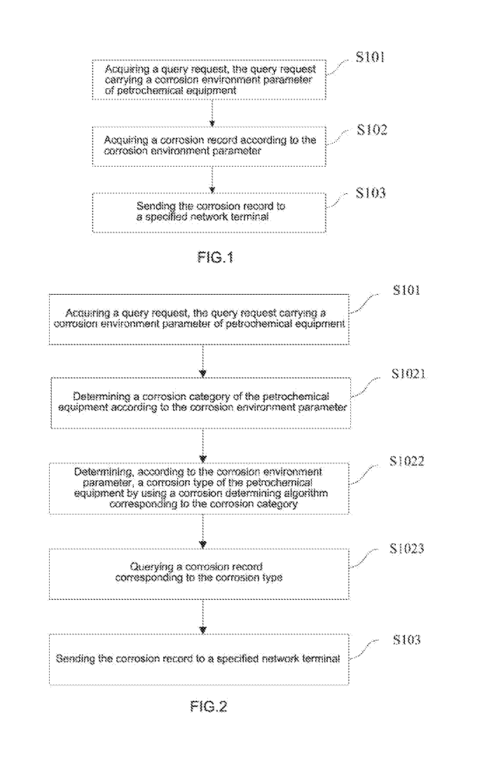

Further, Step S102, that is, the step of acquiring a corrosion record according to the corrosion environment parameter, as shown in FIG. 2, can include the steps of:

S1021, determining a corrosion category of the petrochemical equipment according to the corrosion environment parameter, the corrosion category including corrosion thinning, stress corrosion cracking, mechanical fatigue and metallurgy failure;

S1022, determining, according to the corrosion environment parameter, a corrosion type of the petrochemical equipment by using a corrosion determining algorithm corresponding to the corrosion category; and

S1023, querying a corrosion record corresponding to the corrosion type.

In other words, a category corresponding to the corrosion environment parameter is firstly determined through Step S1021, that is, a main class to which the petrochemical equipment belongs is determined, and then an algorithm corresponding to this main class is used through Step S1022 to determine a specific corrosion type of this petrochemical equipment; and accordingly, in step S1023, a corrosion record corresponding to the corrosion type is queried. Thus, guiding suggestions and general data as well as historic corrosion cases can be searched in a way as shown in Table 1.

Specifically, as for the category of corrosion thinning, corrosion discrimination modes for 20 types of corrosion thinning are included, for example, the types of corrosion thinning include: hydrochloric acid corrosion, naphthenic acid corrosion, high-temperature sulfur corrosion, carbon dioxide corrosion, oxidation corrosion, microbiological corrosion, flue gas dew point corrosion, soot corrosion, ammonium chloride corrosion, sulfuric acid corrosion, phosphoric acid corrosion, hydrofluoric acid corrosion, high-temperature hydrogen corrosion, high-temperature hydrogen/sulfureted hydrogen corrosion, acidic water corrosion, electrochemical corrosion, amine corrosion, caustic alkali corrosion, cooling water corrosion, and corrosion under insulation; as for the category of stress corrosion cracking, corrosion discrimination modes for 10 types of stress corrosion cracking are included, for example, the stress corrosion cracking (SCC for short) is: chloride SCC, nitrate SCC, caustic alkali SCC, carbonate SCC, amine SCC, ammonia SCC, polythionic acid SCC, wet sulfureted hydrogen damage, hydrofluoric acid SCC or hydrogen embrittlement; and the corrosion discrimination modes for the category of mechanical fatigue and for the category of metallurgy failure mainly include: graphitization, carburization, decarburization, metal pulverization, temper embrittlement, reheat cracking, mechanical fatigue, metal pulverization, demetalization, nitridation, embrittlement at 475° C., stress aging, liquid metal embrittlement, thermal shock, brittle fracture and so on.

The corresponding corrosion record may be searched by calculating a corrosion rate firstly besides being based on the corrosion type. A module for calculating a corrosion rate can be developed based on corrosion thinning rate data in the standard API RP 581 Risk-Based Inspection, has good accuracy and can be used for estimation of corrosion rates of 12 types of corrosion damage, wherein these 12 types mainly include: hydrochloric acid corrosion, high-temperature sulfur corrosion, naphthenic acid corrosion, high-temperature hydrogen/sulfureted hydrogen corrosion, sulfuric acid corrosion, hydrofluoric acid corrosion, acidic water corrosion, amine corrosion, oxidation corrosion, cooling water corrosion, soil corrosion and carbon dioxide corrosion. For example, if corrosion environment parameters such as a sulfur content of 1.5 wt %, an acid value of 0.2 mgKOH/g, a temperature of 300′C, and a material of 1Cr5Mo are input, after calculation, a corrosion rate of 0.138 mm/y is outputted, wherein as to the specific calculation formula, reference can be made to the calculation formula for high-temperature sulfur plus naphthenic acid corrosion rate, see appendix B in the standard API RP 581 Risk-Based Inspection.

Specifically, the calculation mode for corrosion rate may be correspondingly adjusted according to different corrosion types. In other words, before the step of calculating the corrosion rate of the petrochemical equipment according to the corrosion environment parameter, it further includes: selecting a corresponding corrosion rate calculation formula according to the corrosion type of the petrochemical equipment.

The step of calculating the corrosion rate of the petrochemical equipment according to the corrosion environment parameter includes: calculating, according to the corrosion environment parameter, the corrosion rate of the petrochemical equipment by using the corrosion rate calculation formula.

After the calculation of the corrosion rate of the petrochemical equipment, the corrosion rate can be directly used as the corrosion record and sent to a preset network terminal. The corrosion rate can also be utilized to query a historic record corresponding to the corrosion rate as the corrosion record, and the historic record here mainly refers to a corrosion case and a corresponding guiding opinion. Giving corresponding corrosion cases and guiding opinion regarding a specific corrosion rate provided by the user is more targeted and has a higher reference value.

Further, the step of querying a corrosion record corresponding to the corrosion type includes the steps of:

querying, from a corrosion case database, a historic case corresponding to the corrosion type, with the historic case as the corrosion record, wherein the historic case includes one or more of conduit data, container data, tower data, reactor data, heat exchanger data, air cooler data and heating furnace data.

Specifically, one database can be established separately regarding each kind of data, and after the determination of the corrosion type, targeted retrieval can be performed in a certain database. If a certain corrosion type is determined mainly by reference to the reactor data and the heat exchanger data, retrieval can be performed only in a reactor database and a heat exchanger database, without retrieving in other databases.

Further, the step of querying from a corrosion case database a historic case corresponding to the corrosion type with the historic case as the corrosion record includes the steps of:

acquiring a query type of the historic case from the query request; and

querying the historic case in a database corresponding to the query type of the historic case, wherein the query type includes one or more of apparatus type, equipment type, equipment name, corrosion location and medium type.

If the query request provided by the user (client) carries a query type, query can be performed directly in a corresponding database, without performing query in the database of each type anymore, and system load can be accordingly lowered. Of course, the query type may also be inputted by a system operator.

In the course of query, two modes may be used, with one being exact search and the other being ambiguous search, wherein although the number of the results searched via exact search is relatively small, for the searched keyword, the results searched via exact search have a great probability to be matched with the keyword. Nevertheless, only relying on exact search, it cannot satisfy the requirements of the search, and under some circumstances, an equivalent variant of the keyword and a synonym of the keyword may also be used as keywords, and search may be performed again, so as to expand the search scope.

That is to say, the step of querying from a corrosion case database a historic case corresponding to the corrosion type with the historic case as the corrosion record includes the steps of:

judging, according to an identification of the query request, whether the query request is an exact query request; and

if yes, acquiring a first query keyword from the exact query request and using the first query keyword to search the historic case in the corrosion case database; and

if not, determining the query request as an ambiguous query request, acquiring a second query keyword from the ambiguous query request, and using a word having the same or similar meaning to the second query keyword as the keyword to search the historic case in the corrosion case database.

In order to reduce the consumption of the system, data can be stored after being divided into two parts, in the case of storage of various data (e.g. images and videos), wherein one part involves name of the data (e.g. name and code of an image), and the other part stored involves the substantive content of the data (e.g. the content of an image, the content of a video), and similarly, search can also be performed in two steps, that is to say, in the first step, the name of a file can firstly be searched in a manner of keyword, and then the storage location of the corresponding file can be determined according to the name, and accordingly, the content of the file can be searched at the corresponding storage location. In other words, the step of querying from a corrosion case database a historic case corresponding to the corrosion type with the historic case as the corrosion record includes the following two steps:

querying a name of the historic case corresponding to the corrosion type from a name list of the corrosion case database; and

querying, from a data storage of the corrosion case database, a case corresponding to the name of the historic case, with the queried case as the corrosion record.

Specifically, the corrosion case referred to here may be a file of a multimedia type such as an image, a video, etc. The system consumption can be reduced and the load of the system can be lowered by firstly querying a corresponding name from a name list and then searching corresponding data content.

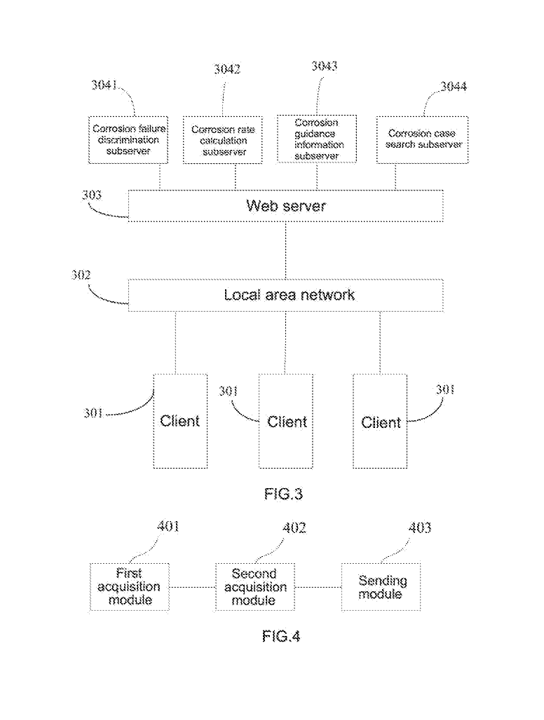

In the following contents, a specific instance will be described for illustrating the working procedure of the method for treatment of corrosion of petrochemical equipment provided in the present application, as shown in FIG. 3:

1. A user sends an operation request information to a Web server 303 by means of a local area network 302 by logging in the browser of a client 301, and the operation request information carries identification information and a corrosion environment parameter, wherein the identification information at least includes one of: corrosion guidance information identification, corrosion case identification, corrosion rate calculation identification and corrosion failure discrimination identification;

2. The Web server 303 distributes the operation request information, according to the identification information carried therein, to a corresponding database for processing. If the identification information includes corrosion rate calculation identification and corrosion failure discrimination identification, a corrosion failure discrimination subserver 3041 determines, according to the corrosion environment parameter, the corrosion type of the petrochemical equipment corresponding to the corrosion environment parameter, and a corrosion rate calculation subserver 3042 calculates the corrosion efficiency of the petrochemical equipment according to the corrosion environment parameter;

3. (optionally), The Web server 303, according to the corrosion type, searches a corresponding guidance information (the guidance information includes basic characteristics of corrosion, corrosion mechanisms, corrosion morphologies, sensitive materials, influencing factors, corrosion-prone apparatuses and equipment, monitoring and detecting modes, and protective measures) by utilizing a corrosion guidance information subserver 3043, and searches a corresponding failure case by utilizing a corrosion case search subserver 3044;

4. The Web server 303 sends the results obtained in Steps 2 and 3 (including corrosion type, corrosion rate, guidance information (optional) and failure cases (optional)) to the client 301 where the user logged in;

5. The user performs corresponding treatment based on the received content, and then completes the treatment, maintenance and overhaul regarding the corrosion of the petrochemical equipment.

An example of the present invention further provides an apparatus for treatment of corrosion of petrochemical equipment, as shown in FIG. 4, including:

a first acquisition module 401, configured for acquiring a query request which carries a corrosion environment parameter of the petrochemical equipment, wherein the corrosion environment parameter includes one or more of corrosive medium, temperature, flow rate and material;

a second acquisition module 402, configured for acquiring a corrosion record according to the corrosion environment parameter, wherein the corrosion record includes one or more of: basic characteristics of corrosion, corrosion mechanisms, corrosion morphologies, sensitive materials, influencing factors, corrosion-prone apparatuses and equipment, monitoring and detecting modes, protective measures and failure cases; and

a sending module 403, configured for sending the corrosion record to a preset network terminal.

Specifically, the second acquisition module includes:

a first determining unit, configured for determining a corrosion category of the petrochemical equipment according to the corrosion environment parameter, the corrosion category including corrosion thinning, stress corrosion cracking, mechanical fatigue and metallurgy failure;

a second determining unit, configured for determining, according to the corrosion environment parameter, a corrosion type of the petrochemical equipment by using a corrosion determining algorithm corresponding to the corrosion category; and

a query unit, configured for querying a corrosion record corresponding to the corrosion type.

Preferably, as to the apparatus for treatment of corrosion of petrochemical equipment, the second acquisition module includes:

a calculation module, configured for calculating the corrosion rate of the petrochemical equipment according to the corrosion environment parameter, the corrosion environment parameter including one or more of corrosive medium, temperature, flow rate and material; and

a query module, configured for querying a historic record corresponding to the corrosion rate as the corrosion record.

Preferably, the query unit includes:

a first query subunit, configured for querying, from a corrosion case database, a historic case corresponding to the corrosion type, with the historic case as the corrosion record,

wherein the historic case includes one or more of conduit data, container data, tower data, reactor data, heat exchanger data, air cooler data and heating furnace data.

Preferably, the query unit specifically has the following functions:

acquiring a query type of the historic case from the query request; and

querying the historic case in a database corresponding to the query type of the historic case, wherein the query type includes one or more of apparatus type, equipment type, equipment name, corrosion location and medium type.

Preferably, the query unit specifically further has the following functions:

judging, according to an identification of the query request, whether the query request is an exact query request; and

if yes, acquiring a first query keyword from the exact query request and using the first query keyword to search the historic case in the corrosion case database; and

if not, determining the query request as an ambiguous query request, acquiring a second query keyword from the ambiguous query request, and using a word having the same or similar meaning to the second query keyword as the keyword to search the historic case in the corrosion case database.

Preferably, the query unit specifically further has the following functions:

querying a name of the historic case corresponding to the corrosion type from a name list of the corrosion case database; and

querying, from a data storage of the corrosion case database, a case corresponding to the name of the historic case, with the queried case as the corrosion record.

An example of the present invention further provides a system for treatment of corrosion of petrochemical equipment, including: a client and a server,

wherein the client is used for acquiring a corrosion environment parameter of the petrochemical equipment and sending the corrosion environment parameter of the petrochemical equipment to the server via an Internet; and

the server includes the apparatus for treatment of corrosion of petrochemical equipment in the examples mentioned above.

The method, apparatus and system for treatment of corrosion of petrochemical equipment provided in the present invention realize the identification of the reason for corrosion failure of the petrochemical equipment, the calculation of the corrosion rate, and sorting out, statistical analysis, query and feedback of the corrosion failure cases. Through the corrosion rate calculation subserver the corrosion failure discrimination subserver, as well as the corrosion guidance information subserver and the corrosion case search subserver, the reason for the occurrence of the corrosion failure of the petrochemical equipment under a given working condition is rapidly determined, and the type of the corrosion case is predicted and identified, which help relevant persons in the petrochemical industry to provide technical support for performance of the corrosion type analysis, corrosion accident diagnosis, and corrosion accident treatment and prevention, and even an analyst without sufficient experience also can complete the treatment of corrosion of petrochemical equipment according to the corrosion type, corresponding guiding suggestion and relevant cases.

It should be noted that:

1. The components and steps, the number expression and values depicted in these examples do not limit the scope of the present invention.

2. As to the apparatus provided in the examples of the present invention, the implementation principle thereof and the technical effects produced thereby are the same as those of the preceding examples regarding the method, and for simplification, as to the contents not mentioned in the part of the examples regarding the apparatus, reference can be made to corresponding contents in the preceding examples regarding the method.

3. Similar reference signs and letters represent similar items in the following drawings, thus, once a certain item is defined in a drawing, no further definition and explanation are needed to be provided in the following drawings.

A person skilled in the art could clearly understand that for convenience and conciseness of the description, as to the specific working processes of the system, the apparatus and the unit described in the preceding contents, reference can be made to the corresponding process in the preceding examples regarding the method, which will be repeated here.

The above are merely specific embodiments of the present invention, whereas the scope of protection of the present invention is not limited thereto; and any technical person familiar with the present technical field could readily think of a modification or substitution within the technical scope disclosed in the present invention, and this shall be covered by the scope of protection of the present invention. Thus, the scope of protection of the present invention shall be defined by the scope of protection of the appended claims.

1. A method for treatment of corrosion of petrochemical equipment, comprising steps of:
acquiring a query request, the query request carrying a corrosion environment parameter of the petrochemical equipment, wherein the corrosion environment parameter comprises one or more of corrosive medium, temperature, flow rate and material;
acquiring a corrosion record according to the corrosion environment parameter, wherein the corrosion record comprises one or more of: basic characteristics of corrosion, corrosion mechanisms, corrosion morphologies, sensitive materials, influencing factors, corrosion-prone apparatuses and equipment, monitoring and detecting modes, protective measures and failure cases; and
sending the corrosion record to a preset network terminal.

2. The method for treatment of corrosion of petrochemical equipment according to claim 1, wherein the step of acquiring a corrosion record according to the corrosion environment parameter comprises steps of:
determining a corrosion category of the petrochemical equipment according to the corrosion environment parameter, the corrosion category comprising corrosion thinning, stress corrosion cracking, mechanical fatigue and metallurgy failure;
determining, according to the corrosion environment parameter, a corrosion type of the petrochemical equipment by using a corrosion determining algorithm corresponding to the corrosion category; and
querying a corrosion record corresponding to the corrosion type.

3. The method for treatment of corrosion of petrochemical equipment according to claim 1, wherein the step of acquiring a corrosion record according to the corrosion environment parameter comprises steps of:
calculating a corrosion rate of the petrochemical equipment according to the corrosion environment parameter; and
querying a historic record corresponding to the corrosion rate, with the historic record as a corrosion record.

4. The method for treatment of corrosion of petrochemical equipment according to claim 2, wherein the step of querying a corrosion record corresponding to the corrosion type comprises steps of:
querying, from a corrosion case database, a historic case corresponding to the corrosion type, with the historic case as the corrosion record,
wherein the historic case comprises one or more of conduit data, container data, tower data, reactor data, heat exchanger data, air cooler data and heating furnace data.

5. The method for treatment of corrosion of petrochemical equipment according to claim 4, wherein the step of querying from a corrosion case database a historic case corresponding to the corrosion type with the historic case as the corrosion record comprises steps of:
acquiring a query type of the historic case from the query request; and
querying the historic case in a database corresponding to the query type of the historic case, wherein the query type comprises one or more of apparatus type, equipment type, equipment name, corrosion location and medium type.

6. The method for treatment of corrosion of petrochemical equipment according to claim 4, wherein the step of querying from a corrosion case database a historic case corresponding to the corrosion type with historic case as the corrosion record comprises steps of:
judging, according to an identification of the query request, whether the query request is an exact query request, wherein if yes, a first query keyword is acquired from the exact query request and the first query keyword is used to search the historic case in the corrosion case database; and if not, the query request is determined as an ambiguous query request, a second query keyword is acquired from the ambiguous query request, and a word having same or similar meaning to the second query keyword is used as a keyword to search the historic case in the corrosion case database.

7. The method for treatment of corrosion of petrochemical equipment according to claim 6, wherein the step of querying from a corrosion case database a historic case corresponding to the corrosion type with the historic case as the corrosion record comprises steps of:
querying a name of the historic case corresponding to the corrosion type from a name list of the corrosion case database; and
querying, from a data storage of the corrosion case database, a case corresponding to the name of the historic case, with the queried case as the corrosion record.

8. An apparatus for treatment of corrosion of petrochemical equipment, comprising:
a first acquisition module, configured for acquiring a query request which carries a corrosion environment parameter of the petrochemical equipment, wherein the corrosion environment parameter comprises one or more of corrosive medium, temperature, flow rate and material;
a second acquisition module, configured for acquiring a corrosion record according to the corrosion environment parameter, wherein the corrosion record comprises one or more of: basic characteristics of corrosion, corrosion mechanisms, corrosion morphologies, sensitive materials, influencing factors, corrosion-prone apparatuses and equipment, monitoring and detecting modes, protective measures and failure cases; and
a sending module, configured for sending the corrosion record to a preset network terminal.

9. The apparatus for treatment of corrosion of petrochemical equipment according to claim 8, wherein the second acquisition module comprises:
a first determining unit, configured for determining a corrosion category of the petrochemical equipment according to the corrosion environment parameter, the corrosion category comprising corrosion thinning, stress corrosion cracking, mechanical fatigue and metallurgy failure;
a second determining unit, configured for determining, according to the corrosion environment parameter, a corrosion type of the petrochemical equipment by using a corrosion determining algorithm corresponding to the corrosion category; and
a query unit, configured for querying a corrosion record corresponding to the corrosion type.

10. A system for treatment of corrosion of petrochemical equipment, comprising: a client and a server,
wherein the client is configured for acquiring a corrosion environment parameter of the petrochemical equipment and sending the corrosion environment parameter of the petrochemical equipment to the server via an Internet; and
the server comprises the apparatus for treatment of corrosion of petrochemical equipment according to claim 8.

11. A system for treatment of corrosion of petrochemical equipment, comprising: a client and a server,
wherein the client is configured for acquiring a corrosion environment parameter of the petrochemical equipment and sending the corrosion environment parameter of the petrochemical equipment to the server via an Internet; and
the server comprises the apparatus for treatment of corrosion of petrochemical equipment according to claim 9.
